(19) United States
(12) Patent Application Publication
(10) Pub. No.: US 2025/0162236 A1
(43) Pub. Date: May 22, 2025

(54) METHOD OF MANUFACTURING A MEASURING TUBE OF A FLUID MEASURING MEANS

(71) Applicants: BUERKERT WERKE GMBH & CO. KG, Ingelfingen (DE); Burkert, Triembach-au-Val (FR); L'Ecole National Superieure d'Arts et Metiers (ENSAM), Paris (FR); AMVALOR, Paris (FR)

(72) Inventors: Yannick FUCHS, Triembach-au-Val (FR); Manon DRUI, Triembach-au-Val (FR); Cyrille BAUDOUIN, Paris (FR); Damien NOIZILLIER, Paris (FR)

(21) Appl. No.: 18/951,865

(22) Filed: Nov. 19, 2024

(30) Foreign Application Priority Data
Nov. 21, 2023 (FR) 2312813

(51) Int. Cl. B29C 57/06; B29L 31/00

(52) U.S. Cl. CPC B29C 57/06; B29L 2031/752

(57) ABSTRACT

In a method of manufacturing a measuring tube of a fluid measuring device, a tubular semi-finished product having a through-opening extending in a longitudinal direction (L) of the tubular semi-finished product is provided, a circumferential wall of the tubular semi-finished product having at least one waveguide area which, after completion of the measuring tube, forms a waveguide for surface acoustic waves of an acoustic measuring device, and the waveguide area extending along a longitudinal direction (L) of the tubular semi-finished product and from an outer surface to an inner surface of the tubular semi-finished product. The tubular semi-finished product is inserted into a forming tool, and at least one mandrel is inserted into the through-opening, an outer geometry of the mandrel corresponding to an inner geometry of a fluid channel of the measuring tube to be formed from the through-opening. In a forming step in which a pressing force (F) is applied to at least one axial center section of the semi-finished product, at least the center section is plastically deformed, the through-opening being formed into the fluid channel. Finally, the mandrel is removed.

### TECHNICAL FIELD

The present disclosure relates to a method of manufacturing a measuring tube of a fluid measuring means having at least one waveguide area.

### BACKGROUND

The measuring tube used in such fluid measuring means has a continuous fluid channel, the surface acoustic waves to be coupled in or out running in a waveguide in a wall of the measuring tube.

The object of the present disclosure is to present a method by which such a measuring tube can be manufactured in a simple and cost-effective manner, but nevertheless with high precision.

### SUMMARY

The present disclosure provides a method of manufacturing a measuring tube of a fluid measuring device, which comprises the following steps:
providing a tubular semi-finished product having a through-opening extending in a longitudinal direction of the tubular semi-finished product, a circumferential wall of the tubular semi-finished product having at least one waveguide area which, after completion of the measuring tube, forms a waveguide for surface acoustic waves of an acoustic measuring device, the waveguide area extending along a longitudinal direction of the tubular semi-finished product and from an outer surface to an inner surface of the tubular semi-finished product,
inserting the tubular semi-finished product into a forming tool,
introducing at least one mandrel into the through-opening, an outer geometry of the at least one mandrel corresponding to an inner geometry of a fluid channel of the measuring tube to be formed from the through-opening,
performing a forming step in which a pressing force is applied to at least one axial center section of the tubular semi-finished product and at least the center section is plastically deformed, the through-opening being formed into the fluid channel, and removing the at least one mandrel.

The outer geometry of the mandrel is transferred to the inner surface of the through-opening in the forming step, the fluid channel thus obtaining its desired cross-section. In this way, a precise inner geometry of the fluid channel can be produced in a few simple and quick process steps and in an easily reproducible manner.

The excitation, measurement, and coupling-in and coupling-out of the surface acoustic waves usually take place purposefully at the waveguides formed on the measuring tube. The waveguides are usually an integral part of the measuring tube, but in the finished measuring tube, they may differ geometrically from the remaining wall of the fluid channel. For example, the waveguides have a plane outer geometry, so that the measuring tube has a flat surface within the area of the waveguides. In most cases, the waveguides are formed as rectangles, the long sides of which are aligned parallel to the longitudinal direction of the fluid channel.

In the forming step, the waveguides are also for example manufactured or finished from the waveguide areas. The waveguide areas can be arranged entirely in the center section.

The mandrel is e.g. moved in a straight line and without rotation, which further simplifies the process. The mandrel is usually inserted into the center section without deforming the inner surface of the through-opening.

In the forming step, a radial pressing force advantageously acts on the semi-finished product, which is generated, for example, by means of several radially movable pressing punches. The forming step can be carried out in a cold-forming process or a hot-forming process.

A few variants of the semi-finished product have proven to be sufficient to produce a wide variety of variants for the measuring tube. For example, two semi-finished product variants with different outer and/or inner diameters may be provided.

After completion of the measuring tube, the latter can be used in a fluid measuring means. One or more signal converters which generate or detect the surface acoustic waves are placed on one or more waveguides.

Prior to the forming step, the semi-finished product may have an outer geometry which deviates from the cylindrical shape and defines the waveguide areas and damping elements and/or reflection elements for surface acoustic waves, this outer geometry being at least partially retained during the forming step. This includes, for example, bevels and/or modified material thicknesses at the longitudinal ends of the subsequent waveguides. This makes it possible, for example, to already machine the measuring tube prior to the forming step to prefabricate the desired components that are to be provided later on the measuring tube.

In this case, the at least one waveguide area can already be specified on the semi-finished product. The semi-finished product should then be aligned accordingly in the circumferential direction when inserting the semi-finished product into the forming tool.

Additionally and/or alternatively, for example damping elements and/or reflection elements may also be produced during the forming step by the shape of the pressing punch and/or the mandrel or by post-processing the outer surface after the forming step.

The semi-finished product may have areas with different wall thicknesses in the center section and/or in axially adjoining sections, these different wall thicknesses being at least partially retained during the forming step. Alternatively or additionally, such areas may also be produced during the forming step. Changes in the thickness of the circumferential wall of the measuring tube along the circumferential direction and/or in the axial direction can be purposefully used, for example, to limit the surface acoustic waves to the waveguides. Such components can also be easily integrated into the measuring tube in this way.

To obtain a flat waveguide having a constant wall thickness over the dimension of the waveguide, an outer geometry of the center section in the at least one waveguide area may be formed from a rounded to a plane surface. In this way, the waveguide can be designed as a plane rectangular surface on the outer surface of the measuring tube, although the semi-finished product is made from a tube having a circular cylindrical cross-section, which reduces the manufacturing costs.

The long sides of the rectangular surface of the waveguide can be aligned in the longitudinal direction. By using a mandrel which is inserted into the center section, a rectangular surface of this type can also be formed on the inner surface of the fluid channel in the forming step.

With the appropriate geometry of the mandrel and the press punches, it is generally possible to produce a fluid channel having a polygonal cross-section from a semi-finished product having a round cross-section.

For example, to compensate for an elastic component of the deformation, i.e. an amount by which the wall of the measuring tube springs back after the press punches have been removed, it is possible to press the pressing punches against the measuring tube again with a suitable force to obtain the desired plastic deformation as the final result. For repeated forming steps, it is also possible to use mandrels having different outer geometries or different cross-sections.

If necessary, after removal of the at least one mandrel, the same mandrel or a different mandrel can be moved through the fluid channel again to improve the precision of the shaping of the inner geometry of the fluid channel.

In this case, a mandrel may for example be used, which has a slightly larger cross-section than the mandrel inserted into the measuring tube in the forming step. In this case, the inner side of the measuring tube can be smoothed and/or expanded in a purposeful and precise manner by pulling the mandrel therethrough. This allows for precise calibration of the fluid channel with precisely specified dimensions.

Usually, a material removing post-processing of the fluid channel after the forming step can be omitted.

However, it is possible, if necessary, to further smooth the inner surface of the fluid channel by passing suitable abrasive fluids therethrough. For example, in at least one of the method steps, two mandrels are used simultaneously, which are moved from the axial ends of the semi-finished product into the through-opening prior to the forming step and out thereof again after the forming step. The two mandrels should contact each other in the center section such that, if possible, there is no noticeable transition, to create a smooth inner surface in the fluid channel.

In this way, a constriction, for example, of the measuring tube can be produced from the axial ends towards the center section, the fluid channel in the center section being given a smaller cross-sectional area than the fluid connections. For this purpose, each mandrel has a smaller cross-sectional area at an area located in the center section than at an axially adjoining area.

A transition area can be respectively formed from one axial end of the semi-finished product to the center section, in which an inner cross-section and/or an inner geometry of the axial end and of the center section merge steplessly into each other. The inner cross-section and/or the inner geometry can be easily predetermined by the outer geometry, i.e. the shape of the outer circumferential surface of the mandrel. The outer geometry of the mandrel then deviates in an area arranged in the center section from an outer geometry in an axially adjacent area. Due to the fact that the shape of the transition area is predetermined by the mandrel, a high quality of these transition areas can be produced, which is noticeable in a stable flow profile in the fluid channel.

For example, the inner cross-section in the center section may be polygonal and the cross-section located axially further outside at the fluid connection may be circular.

In another variant, exactly one mandrel is used, which is inserted into the through-opening and around which the semi-finished product is deformed. The mandrel is then pulled out of the through-opening to one side.

It is possible to subsequently pull this mandrel through the through-opening once or several times to calibrate the inner geometry of the fluid channel in a calibration step, i.e. to adapt it more precisely to predetermined dimensions.

In such a calibration step, several mandrels which are adapted to each other in their outer contour can be successively guided through the fluid channel to obtain a precise geometry of the inner side of the fluid channel.

It would also be conceivable to perform one or more method steps with two mandrels inserted in opposite directions and to perform one or more other method steps with only one mandrel. For example, a calibration step for the fluid channel could be carried out with only one single mandrel.

The cross-sectional shape of the fluid connections and the fluid channel may be selected at the discretion of a person skilled in the art. For example, an equilateral polygon having 3 to 8 sides, for example, can be used for the fluid channel. However, the polygon may also be a rectangle. Shapes having both rounded and flat sides are also conceivable.

To optimize the forming process, the shape of the semi-finished product and of the forming tool may be selected such that a pressing force is applied only in sections along the circumference of the measuring tube during the forming step. An outer circumference of the center section thus remains approximately identical in sections prior to and after the forming step. For example, the corners of a polygon can lie on the outer circumference of the semi-finished product before forming. Such sections can be located outside the waveguide areas.

It is possible that the axial end sections of the semi-finished product remain undeformed in the forming step.

### BRIEF DESCRIPTION OF THE DRAWINGS

FIG. 1 shows a measuring tube of a fluid measuring means, produced in accordance with a method according to the disclosure, in a schematic partially cut view;

FIGS. 2 and 3 show steps of a method according to the disclosure of manufacturing a measuring tube according to a first variant;

FIGS. 4 and 5 show further steps of the method according to the invention of manufacturing a measuring tube in a forming tool;

FIG. 6 shows a measuring tube manufactured by the method according to the disclosure;

FIGS. 7 to 9 show steps of a method according to the disclosure of manufacturing a measuring tube of a fluid measuring means according to a second variant;

FIGS. 10 to 12 show measuring tubes having different geometries, as manufactured in accordance with a method according to the disclosure;

FIG. 13 show different inner cross-sectional shapes of a fluid channel of a measuring tube manufactured in accordance with the method according to the disclosure;

FIGS. 14 and 15 show a measuring tube having a transition area between a center section and an axially adjoining area, manufactured in accordance with a method according to the disclosure;

FIG. 16 shows a schematic, partially cut view of a measuring tube having different wall thicknesses, manufactured in accordance with the method according to the disclosure; and

FIG. 17 shows a method according to the disclosure of manufacturing producing a measuring tube in a forming tool according to a further variant.

### DETAILED DESCRIPTION

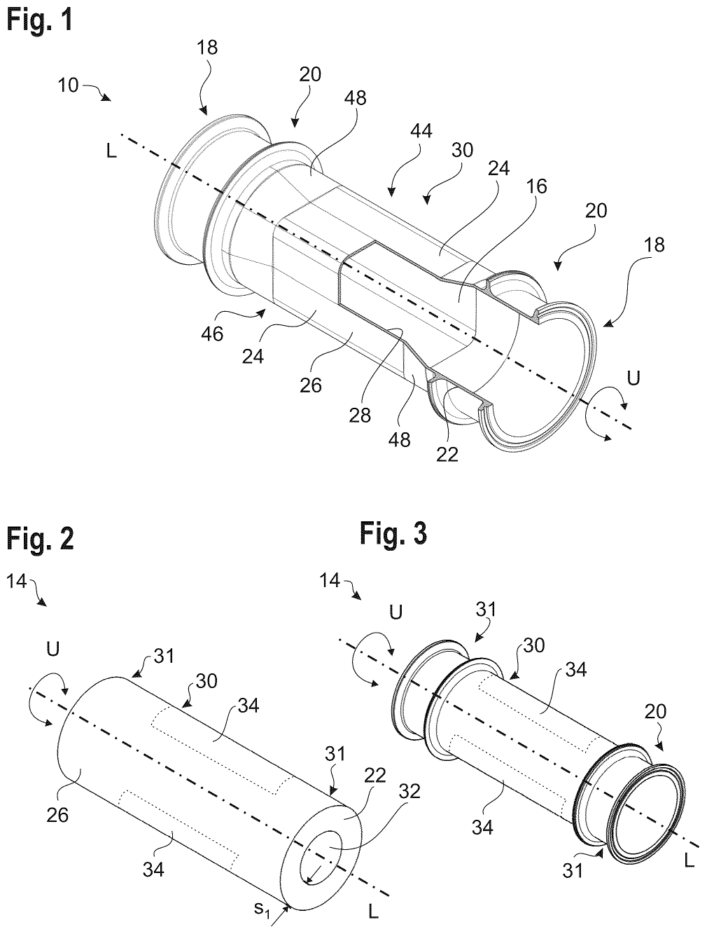

FIG. 1 shows a measuring tube 10 of a flow measuring means, not shown in more detail, which operates according to the principle of measuring surface acoustic waves (SAW).

The measuring tube 10 is made from a tubular semi-finished product 14 (see FIGS. 2 and 7).

The measuring tube 10 has a continuous fluid channel 16 which extends between two fluid connections 18 on opposite sides of the measuring tube 10. During measurement, a suitable fluid to be measured flows through the fluid channel 16.

A connection structure 20, here in the form of two radially protruding flanges, is formed on each of the fluid connections 18, via which the measuring tube 10 can be connected to a fluid system.

One or more waveguides 24 are formed in a circumferential wall 22 of the measuring tube 10. The waveguides 24 are here the areas of the measuring tube 10 at which transmitters and receivers (not shown) for surface acoustic waves are arranged and at which the coupling-in and coupling-out processes of the surface acoustic waves relevant to the measurement also take place.

If several waveguides 24 are provided, these are distributed along the circumferential direction U, but are arranged axially in the same position, for example. The waveguides 24 are formed in one piece with the circumferential wall 22 and extend continuously from an outer surface 26 to an inner surface 28 of the measuring tube 10. The waveguides 24 are located in an axial center section 30 of the measuring tube 10 between the two fluid connections 18. All waveguides 24 extend along a longitudinal direction L of the measuring tube 10, along which the fluid channel 16 also extends. Each of the waveguides 24 is here flat and rectangular, the long sides of the rectangle extending along the longitudinal direction L.

In the fluid measuring means, the waveguide 24 is part of an acoustic measuring device, surface acoustic waves being coupled into and out of the waveguide 24.

A total of at least two signal transmitters are arranged on the waveguides 24, which can excite surface acoustic waves in the waveguide 24 or receive them therefrom (not shown).

The waveguides 24 form a boundary with the fluid flowing through the fluid channel 16, part of the surface acoustic waves traveling through the waveguide 24 being coupled out into the fluid, passing therethrough and being coupled at a different location in the same waveguide 24 or in a different waveguide 24 again and being received by one or more of the signal transmitters.

FIGS. 2 to 6 show the manufacture of the measuring tube 10 from the tubular semi-finished product 14 with reference to a first example.

First, the initially circular cylindrical tubular semi-finished product 14 (see FIG. 2) is optionally processed in a suitable manner so that the connecting structures 20 are produced at the fluid connections 18 at end sections 31 of the semi-finished product 14, which still have a circular cylindrical cross-section (see FIG. 3). These connecting structures 20 can be produced, for example, by milling and/or turning.

The semi-finished product 14 has a through-opening 32 which, after completion, forms the fluid channel 16 of the measuring tube 10.

In this example, the semi-finished product 14 has a relatively large wall thickness s₁, so that material removal can take place on the outer surface 26 to produce the flanges.

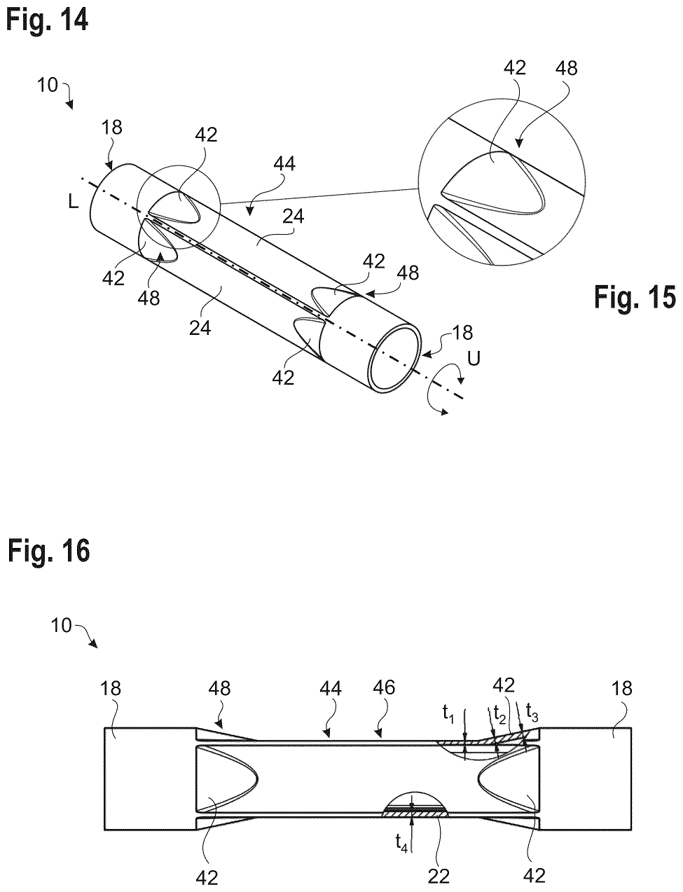

The center section 30 remains unprocessed here, but can optionally already be provided with suitable structures 42 in this step (see, for example, FIGS. 14 to 16), in which, for example, the inclination of the outer surface 26 or the wall thickness of the semi-finished product 14 is changed. Such structures 42 for example form damping elements and/or reflection elements for surface acoustic waves to concentrate these in the area of the subsequent waveguides 24.

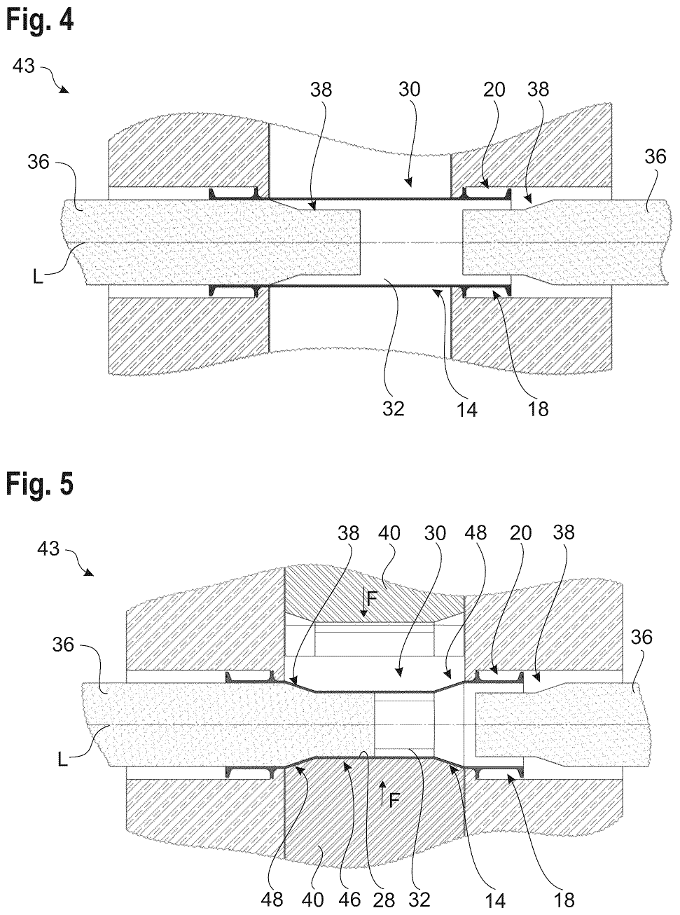

The semi-finished product 14 is placed in a forming tool 43, if necessary after the described pre-processing steps, (see FIG. 4).

On the outer surface 26 of the semi-finished product 14, which later forms the outer surface 26 of the measuring tube 10, one or more waveguide areas 34 are predefined, which form the waveguides 24 in the finished measuring tube 10.

In one variant, the waveguide areas 34 are physically defined on the semi-finished product 14, for example by means of processing steps that have already been carried out in advance and in which the outer surface 26 has for example been machined and structures 42 have been formed, for example. In this case, the semi-finished product 14 is placed in the forming tool 43 such that the waveguide areas 34 are correctly aligned in the circumferential direction U.

In another variant, the waveguide areas 34 are obtained by forming the waveguides 24 at these points of the circumferential wall 22 during the following forming step. If the semi-finished product 14, as shown in FIG. 2, does not yet deviate from a circular cylindrical shape, a purposeful alignment can be dispensed with.

The forming tool 43 comprises two opposed mandrels 36, which can be displaced in a straight line along the longitudinal direction L and the outer geometry 38 of which, in one variant, corresponds exactly in diameter and shape to the desired inner geometry of the fluid channel 16. The dimensions of the mandrels 36 are chosen such that they can be inserted into the through-opening 32 along the longitudinal direction L without deforming the semi-finished product 14. This is shown in FIG. 4.

The two mandrels 36 are inserted into the through-opening 32 until they substantially rest seamlessly against each other in the center of the center section 30.

The ends of the mandrels 36 facing the center of the semi-finished product 14 are here tapered in cross-section compared with axially adjoining sections positioned in the areas of the fluid connections 18 (see FIGS. 4 and 5). Furthermore, these tapered ends here have a different cross-sectional shape than the axially adjoining areas. In a transition area, the cross-sectional shapes merge continuously and steplessly into each other.

The forming tool 43 comprises several pressing punches 40 which can be displaced radially to the longitudinal direction L. The semi-finished product 14 is held in the forming tool 43 such that the pressing punches 40 act exclusively on the center section 30. This is shown in FIG. 5. In a forming step in which a pressing force F is applied to the axial center section 30 of the semi-finished product 14, the center section 30 is plastically deformed. The pressing punches 40 are displaced radially so that the circumferential wall 22 in the center section 30 is pressed against the mandrels 36 and is thus plastically deformed. This forming step can be carried out as a hot or cold forming step.

The through-opening 32 is thus formed into the fluid channel 16.

The geometry of the center section 30 is predetermined at the outer surface 26 by the contour of the pressing punches 40 and at the inner surface 28 of the through-opening 32 by the outer geometry 38 of the mandrels 36. The fluid channel 16 thus produced is given the outer geometry 38 of the mandrels 36 as its inner geometry.

Depending on an elastic component of the deformation, the forming tool 43, for example, is closed only once or several times to produce the desired inner geometry of the fluid channel 16.

In another variant, the outer geometry 38 of the mandrel 36 is selected to be slightly smaller than the desired cross-section of the fluid channel 16 to take a spring-back of the material of the measuring tube 10 after the forming step into account.

In a further variant, several consecutive forming steps are carried out with several mandrels 36 having different outer geometries until the fluid channel 16 is completed with the desired dimensions.

In this or these forming step(s), the waveguide areas 34 are also formed into the final waveguides 24. The axial area in which the waveguides 24 extend forms a measuring area 44 in the finished measuring tube 10.

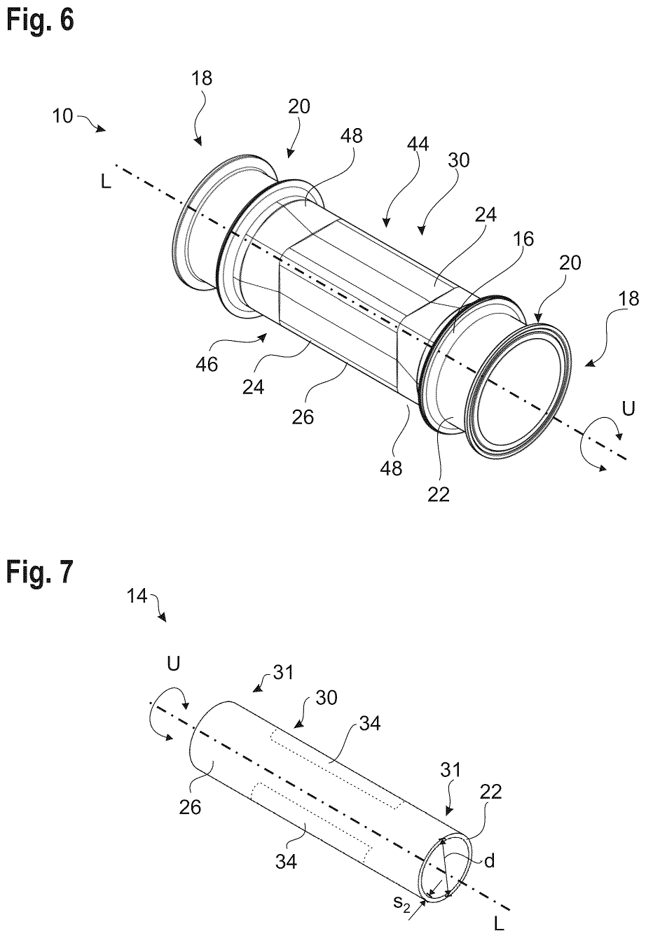

In the axial section of the measuring tube 10 in which the waveguides 24 are arranged, a constriction 46 is also produced here, in which the cross-section of the fluid channel 16 is tapered in comparison with the cross-section at the fluid connections 18 (FIG. 6).

A transition area 48 in which the cross-section from the measuring area 44 to the fluid connections 18 respectively widens continuously and steplessly respectively extends axially between the connection structures 20 and the waveguides 24 (see, for example, FIGS. 1 and 5).

After the forming step, the mandrels 36 are again pulled out of the through-opening 32 along the longitudinal direction L and the forming tool 43 is opened so that the now completed measuring tube 10 can be removed.

The axial end sections 31 in the area of the fluid connections 18 and the connection structures 20 remain undeformed here.

The structures 42 already formed on the semi-finished product 14 before the forming step, for example damping elements and/or reflection elements for surface acoustic waves, including different thicknesses of the circumferential wall 22, remain at least largely unchanged during the forming of the semi-finished product 14.

If necessary, before the measuring tube 10 is removed from the forming tool 43, the mandrels 36 are pushed back into the trough-opening 32, which has now been formed into the fluid channel 16, and pulled out again to smooth the inner surface 28 of the fluid channel 16. It is also conceivable to use other mandrels 36 for this step, which are similar in shape to the mandrels 36 used for the forming, but which, for example, define the inner surface 28 of the fluid channel 16 more precisely in a calibrating step.

Optionally, further post-processing can be carried out, for example to form further elements on the outer surface 26 of the measuring tube 10. The inner surface 28 of the fluid channel 16 is not post-processed here.

However, it would be conceivable, for example, to smooth the inner surface 28 even further using abrasive fluids.

In the example shown, the waveguide areas 34, which are rounded in the circumferential direction U, are formed into flat, rectangular waveguides 24 (see, for example, FIGS. 1 and 6).

In the measuring area 44, the circular cross-sectional shape of the through-opening 32 is formed into an approximately square cross-sectional shape of the fluid channel 16, which has four plane surfaces adjacent to each other at right angles and rounded corners (see, for example, FIG. 6). A waveguide 24 is formed here on each of the sides of the square cross-section.

In the transition areas 48, not only the diameter of the fluid channel 16 changes, but the cross-sectional shape thereof also changes from polygonal to circular.

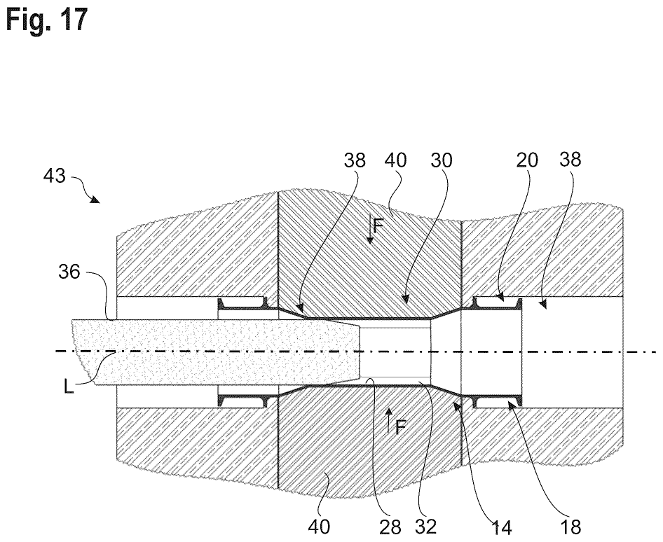

It would also be possible to use only a single mandrel 36 for fluid channels 16 having an inner geometry that is not tapered compared with the fluid connections 18, which is then inserted into the through-opening 32 over the entire center section 30 (see FIG. 17). The cross-section of the mandrel 36 is nowhere larger than the narrowest cross-section of the formed fluid channel 16, so that the mandrel 36 can be pushed completely into the center section 30 and pulled out of it again after forming. The figure shows the step in which the mandrel 36 is pulled out of the fluid channel 16 after the forming.

In this case, too, several mandrels 36 having slightly different outer geometries are optionally used, as described above, to compensate for elastic deformation of the measuring tube 10. A mandrel 36 the outer geometry of which corresponds exactly to the cross-section of the fluid channel 16 is finally optionally moved through the through-opening 32 once or several times to complete the fluid channel 16 exactly with the desired cross-section.

FIG. 13 shows a number of possibilities for a cross-sectional area 50 of the fluid channel 16 in the measuring area 44, for example as a polygon having 3 to 8 faces, wherein the polygon can be regular or irregular, or a hybrid shape having rounded and plane faces. A generally oval or circular cross-sectional shape is of course also conceivable.

FIGS. 7 to 9 show the forming of the semi-finished product 14 with reference to a second example.

In contrast to the first example just described, the semi-finished product 14 has a wall thickness s₂ which is smaller than the wall thickness s₁.

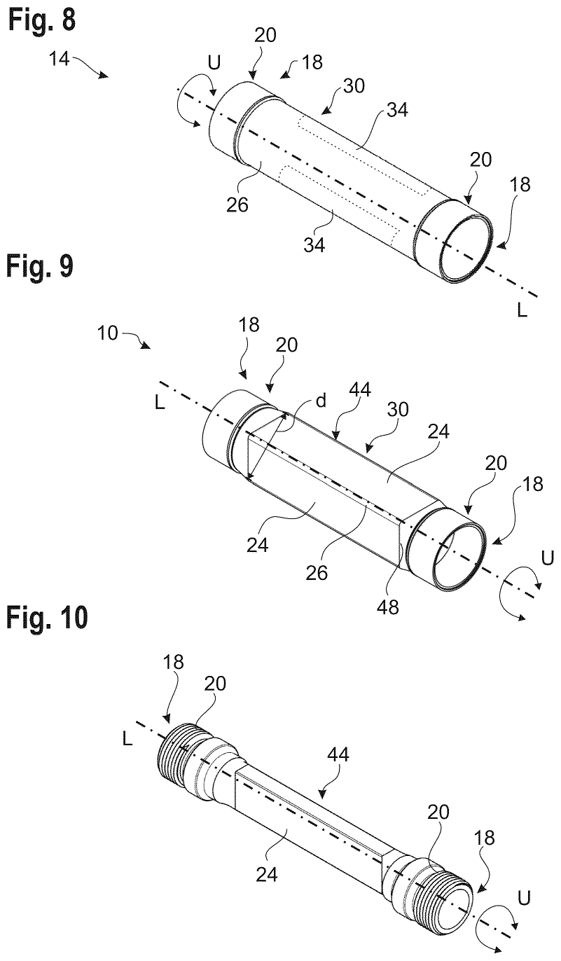

As described above, prior to the insertion into the forming tool 43, the axial ends 31 which form the fluid connections 18 are processed to create suitable connection structures 20 (see FIG. 8).

The semi-finished product 14 is then placed in the forming tool 43 and plastically deformed by the pressing punches 40 and the inserted mandrels 36. FIG. 9 shows the result of the forming step.

In this example, the measuring area 44 has a square cross-sectional shape, as in the first example, with a fluid channel 16 which also has a square cross-section. However, as described above, other cross-sectional shapes could also be realized.

In contrast to the first example, the forming tool 43 is designed such that a pressing force is only applied in sections along the circumference. In this example, these are the later flat side surfaces. No direct force is applied to the intermediate areas, here the respective corners of the square cross-section. In these areas, the diameter d of the finished measuring tube 10 corresponds approximately to the diameter d of the semi-finished product 14 (indicated in FIGS. 7 and 9), and the original outer surface 26 and the original outer circumference of the semi-finished product 14 are at least partially retained.

The previously processed connection structures 20 are not deformed at all or only insignificantly in the forming step. This also applies to any structures 42 that may be present, just as in the first example described above.

FIGS. 10 to 12 show further possible exemplary embodiments of the finished measuring tube 10.

In FIG. 10, the measuring area 44 is formed into a rectangular cross-section. In the circumferential direction U, the sides of the cross-section are therefore of unequal length. For example, waveguides 24 are only formed on the two longer sides.

In addition, the connection structures 20 are here not designed as flanges, but as threads. As described above for the flanges, the threads can also be prefabricated before the forming step and are not deformed in the forming step.

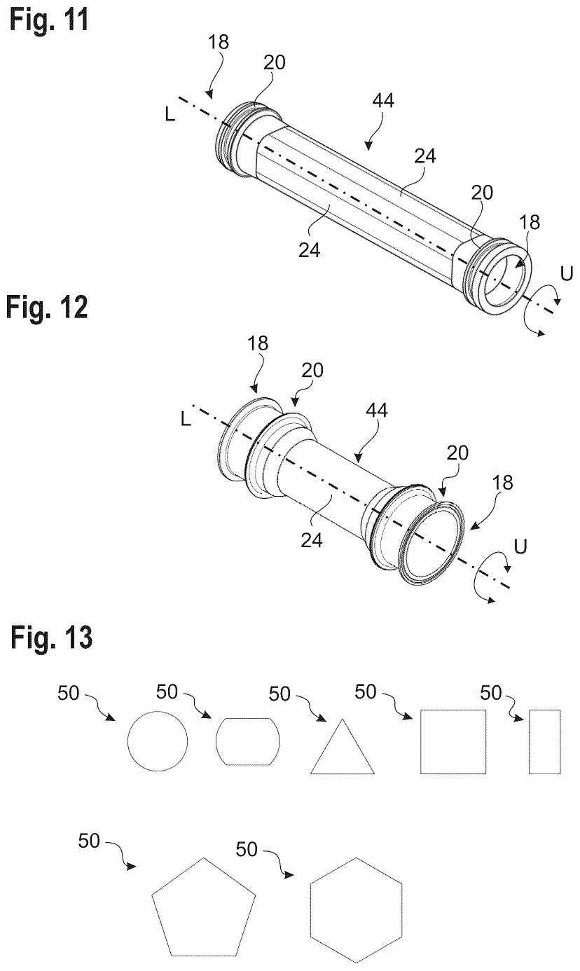

FIG. 11 shows a measuring tube 10 which combines a square cross-section of the fluid channel with a different type of flange at the fluid connections 18.

Finally, FIG. 12 shows a measuring tube 10 having a circular cross-section of the fluid channel 16 in the measuring area 44 and flanges at the fluid connections 18.

Of course, at the discretion of a person skilled in the art, any other designs and combinations of the elements shown are possible. From a few variants of the semi-finished product 14 with regard to diameter d and wall thickness s₁, s₂, a large number of variants of measuring tubes 10 can be produced by varying the pressing punches 40 and the mandrels 36.

FIGS. 14 to 16 show the structures 42 already mentioned above in more detail.

In the transition area 48, a damping and/or reflection element tapering towards the measuring area 44 is formed for each of the waveguides 24 on the measuring tube 10, in which the curvature of the fluid connection 18, which is circular in the peripheral direction U, merges steplessly into the plane surface of the waveguide 24.

In addition, in the transition area 48 and in the structures 42, the cross-section of the measuring tube 10 is reduced from the cross-section of the fluid connection 18 to the cross-section of the fluid channel 16.

Such structures 42 can be prefabricated on the semi-finished product 14 prior to the forming step, produced during the forming step by the pressing punches 40 and the mandrels 36, or produced using a combination of the two methods.

FIG. 16 shows that in this example, the wall thickness of the measuring tube 10 also changes from the waveguide 24 in the measuring area 44 to the fluid connection 18 and in this example increases from a wall thickness t₁ to a wall thickness t₃ via a wall thickness t₂.

Furthermore, it is shown by way of example that the wall thickness optionally also varies in different circumferential areas of the measuring area 44, e.g. for different waveguides 24 or within the waveguides 24 and outside the waveguides 24 (here indicated by t₁ and t₄).

These different wall thicknesses are produced, for example, during the forming step by forming the semi-finished product 14.

All features of the individual embodiments and variants can be freely exchanged or combined with each other at the discretion of a person skilled in the art.

For reasons of clarity, identical components are not always all provided with reference numerals.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of manufacturing a measuring tube of a fluid measuring device, the method comprising:
providing a tubular semi-finished product having a through-opening extending in a longitudinal direction (L) of the tubular semi-finished product, a circumferential wall of the tubular semi-finished product having at least one waveguide area which, after completion of the measuring tube, forms a waveguide for surface acoustic waves of an acoustic measuring device, the waveguide area extending along a longitudinal direction (L) of the tubular semi-finished product and from an outer surface to an inner surface of the tubular semi-finished product;
inserting the tubular semi-finished product into a forming tool;
introducing at least one mandrel into the through-opening, an outer geometry of the at least one mandrel corresponding to an inner geometry of a fluid channel of the measuring tube to be formed from the through-opening;
performing a forming step in which a pressing force (F) is applied to at least one axial center section of the tubular semi-finished product and at least the center section is plastically deformed, the through-opening being formed into the fluid channel; and
removing of the at least one mandrel.

2. The method according to claim 1, wherein prior to the forming step, the tubular semi-finished product has an outer geometry which deviates from the cylindrical form and defines waveguides, damping elements and/or reflection elements for surface acoustic waves, this outer geometry being at least partially retained during the forming step.

3. The method according to claim 1, wherein the tubular semi-finished product has areas having different wall thicknesses (t₁, t₂, t₃, t₄) in the center section and/or in axially adjoining sections and wherein these different wall thicknesses (t₁, t₂, t₃, t₄) are at least partially retained during the forming step.

4. The method according to claim 1, wherein an outer geometry of the center section in the at least one waveguide area is formed from a surface rounded in a circumferential direction (U) to a surface which is a plane in the circumferential direction (U).

5. The method according to claim 1, wherein, after removal of the at least one mandrel, the same mandrel or another mandrel is moved through the through-opening again.

6. The method according to claim 1, wherein two mandrels are used simultaneously, which are moved from axial ends of the tubular semi-finished product into and out of the through-opening.

7. The method according to claim 6, wherein each mandrel has a smaller cross-sectional area at an area arranged in the center section than at an axially adjoining area.

8. The method according to claim 7, wherein in the forming step, a transition area is respectively formed from one axial end of the tubular semi-finished product to the center section, in which an inner cross-section and/or an inner geometry of the axial end and of the center section merge steplessly into each other.

9. The method according to claim 1, wherein exactly one mandrel is introduced into the through-opening.

10. The method according to claim 1, wherein during the forming step, a pressing force F is exerted only in sections along the circumference (U) of the measuring tube.

11. The method according to claim 1, wherein axial end sections of the tubular semi-finished product remain undeformed in the forming step.
